(19) United States
(12) Patent Application Publication
(10) Pub. No.: US 2023/0238619 A1
(43) Pub. Date: Jul. 27, 2023

(54) METHOD OF PACKAGING BATTERY DEVICES

(71) Applicants: Dow Global Technologies LLC, Midland, MI (US); Rohm and Haas Company, Collegeville, PA (US)

(72) Inventors: Li Zhou, Shanghai (CN); Daoshu Lin, Shanghai (CN); Dong Yun, Shanghai (CN); Fengzhe Shi, Shanghai (CN)

(21) Appl. No.: 18/010,503

(22) PCT Filed: Jul. 30, 2020
(86) PCT No.: PCT/CN2020/105702

§ 371 Date: Dec. 15, 2022

(51) Int. Cl. H01M 50/124; H01M 50/133

(52) U.S. Cl. CPC H01M 50/1245; H01M 50/133

(57) ABSTRACT

A method of packaging a battery device with a metal shell, comprising: applying a waterborne two-component polyurethane composition to the metal shell of the battery device, and drying the applied polyurethane composition to form a packaging layer; wherein the polyurethane composition comprises, (A) an aqueous dispersion comprising a hydroxyl-functional polymer, wherein the hydroxyl-functional polymer comprises, by weight based on the weight of the hydroxyl-functional polymer, from 20% to 50% of structural units of a hydroxy-functional alkyl (meth)acrylate; from 0.1% to 10% of structural units of an acid monomer, a salt thereof, or mixtures thereof; and structural units of a monoethylenically unsaturated nonionic monomer; and (B) a polyisocyanate.

### FIELD OF THE INVENTION

The present invention relates to a method of packaging a battery device and a battery package obtained therefrom.

### INTRODUCTION

Battery packs comprising a plurality of battery cells packed together are becoming important in the electrical vehicles industry. Each battery cell typically comprises an electrode core, an electrolyte solution, and a metal shell with the electrode core and electrolyte solution being located in the chamber of the metal shell. The battery cell also needs to be encapsulated with one or more packaging layer which provides adequate electrical insulation and mechanical protection to the battery cell. For example, the packaging layer needs to have good electrical insulation properties to prohibit short circuit of battery cells, for example, a volume resistance of 10¹² ohm centimeters (ohm·cm) or higher. When battery packs are used in electrical vehicles, the packaging layer for each cell also needs to have balanced flexibility and hardness, as well as anti-abrasion properties to withstand continuous vibration and abrasion throughout life cycles of the battery packs. Packaging materials for battery cells also need to have sufficient chemical resistance to avoid potential damages caused by leaking electrolytes or other chemicals used in the production of battery cells. It is further desirable for the packaging layer of battery cells to have good appearance, for example, affording a high distinctness of image (DOI) (e.g., 74 or higher).

One of conventional approaches for packaging flat batteries is adhering polyester films to the surface of the metal shell of battery cells by a heat- or pressure-sensitive adhesive, but this approach suffers from limitations such as bubbles and defects caused by insufficient adhesion between polyester films and the metal shell, which adversely affects the electrical insulation properties of battery cells. Moreover, polyester films usually cannot withstand continuous vibration and abrasion for their low hardness such as a pencil hardness of around 2B. Ultraviolet (UV) curing paints may have improved hardness while unsatisfactory electrical insulation or mechanical properties make them not suitable for packaging battery cells.

The battery industry also has strict manufacturing requirements for safety. For example, battery manufacturers require materials with high flash point (for example, higher than 60° C.) to avoid fire hazards associated with equipment failure. In addition, solvent-borne compositions are usually not accepted by battery manufacturers as these compositions contribute volatile organic compounds (VOCs) and most of the solvents such as dimethylbenzene and methylbenzene have flash points much lower than 60° C. Battery cells can only withstand a baking temperature up to 100° C., preferably, 80° C. or lower. Therefore, it is further desirable that packaging battery cells can be conducted using existing manufacturing equipment and conditions.

It is desirable to discover a method of packaging battery cells that can replace conventional packaging methods without the aforementioned problems.

### SUMMARY OF THE INVENTION

The present invention solves the problem of discovering a method of packaging a battery device yet that can be used to replace conventionally packaging approaches without the aforementioned problems.

The present invention provides a novel method of packaging a battery device with a metal shell by applying a specific waterborne two-component polyurethane composition that comprises an aqueous dispersion comprising a hydroxyl-functional polymer and a polyisocyanate, and drying the polyurethane composition to form a packing layer. The packaging layer can show good electrical insulation properties while providing balanced mechanical properties, such as a volume resistivity (VR) of 10¹² ohm centimeters (ohm·cm) or higher, an impact resistance of 10 centimeters (cm) at 0.91 kilograms (kg) or higher, an adhesion rating of 5B, and chemical resistance of 100 times or higher, at a film thickness of from 30 μm to 120 μm. These properties can be measured according to the test methods described in the Examples section below. The method of the present invention can also be conducted using existing manufacturing facilities as conventional polyester films for packaging battery devices without requiring the step of applying adhesive materials.

In a first aspect, the present invention is a method of packaging a battery device with a metal shell. The method comprises: applying a waterborne two-component polyurethane composition to the metal shell of the battery device, and drying the applied polyurethane composition to form a packaging layer; wherein the polyurethane composition comprises, (A) an aqueous dispersion comprising a hydroxyl-functional polymer, wherein the hydroxyl-functional polymer comprises, by weight based on the weight of the hydroxyl-functional polymer, from 20% to 50% of structural units of a hydroxy-functional alkyl (meth)acrylate; from 0.1% to 10% of structural units of an acid monomer, a salt thereof, or mixtures thereof; and structural units of a monoethylenically unsaturated nonionic monomer; and (B) a polyisocyanate.

In a second aspect, the present invention is a battery package obtained from the method of the first aspect.

### DETAILED DESCRIPTION OF THE INVENTION

“Aqueous” composition or dispersion herein means that particles dispersed in an aqueous medium. By “aqueous medium” herein is meant water and from 0 to 30%, by weight based on the weight of the medium, of solvent(s) such as, for example, naphtha and water-miscible solvents such as alcohols, glycols, glycol ethers, and glycol esters; or mixtures thereof.

“Structural units”, also known as “polymerized units”, of the named monomer, refers to the remnant of the monomer after polymerization, that is, polymerized monomer or the monomer in polymerized form. For example, a structural unit of methyl methacrylate is as illustrated:

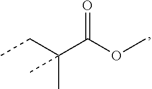

where the dotted lines represent the points of attachment of the structural unit to the polymer backbone.

The waterborne two-component polyurethane composition useful in the present invention comprises two components: part A and part B, where the part A comprises an aqueous dispersion of one or more hydroxyl-functional polymer, and the part B comprises one or more polyisocyanate. As used herein, the term “waterborne” composition refers to a composition in which the liquid medium (or the carrier liquid) is water or a mixture of water and from zero to 50% of a solvent by weight based on the weight of the liquid medium. For example, the liquid medium may comprise more than 60% of water, more than 70% of water, more than 80% of water, or more than 90% of water, by weight based on the total weight of the liquid medium.

The hydroxyl-functional polymer in the aqueous dispersion can be a polymer made by solution polymerization or an emulsion polymer. The hydroxyl-functional polymer useful in the present invention comprises structural units of one or more hydroxy-functional alkyl (meth)acrylate. Suitable hydroxy-functional alkyl (meth)acrylates may include, for example, hydroxyethyl (meth)acrylates such as 2-hydroxyethyl acrylate and 2-hydroxyethyl methacrylate; hydroxypropyl (meth)acrylates such as 2-hydroxypropylacrylate, 2-hydroxypropyl methacrylate, 3-hydroxypropyl acrylate, and 3-hydroxypropyl methacrylate; hydroxybutyl (meth)acrylates such as 3-hydroxybutyl acrylate, 3-hydroxybutyl methacrylate, 4-hydroxybutyl acrylate, and 4-hydroxybutyl methacrylate; 6-hydroxyhexyl acrylate; 6-hydroxyhexylmethacrylate; 3-hydroxy-2-ethylhexyl acrylate; 3-hydroxy-2-ethylhexyl methacrylate; or mixtures thereof. Preferred hydroxy-functional alkyl (meth)acrylates include 2-hydroxyethyl acrylate, 2-hydroxyethyl methacrylate, 3-hydroxypropyl acrylate, 3-hydroxypropyl methacrylate, or mixtures thereof. The hydroxyl-functional polymer may comprise structural units of the hydroxy-functional alkyl (meth)acrylate in an amount of 20% or more, 21% or more, 22% or more, 23% or more, 24% or more, 25% or more, 26% or more, 27% or more, 28% or more, 29% or more, 30% or more, 31% or more, or even 32% or more, and at the same time, 50% or less, 48% or less, 45% or less, 44% or less, 43% or less, 42% or less, 41% or less, 40% or less, 39% or less, 38% or less, 37% or less, 36% or less, 35% or less, or even 34% or less, by weight based on the weight of the hydroxyl-functional polymer.

The hydroxyl-functional polymer useful in the present invention comprises structural units of one or more acid monomer, a salt thereof, or mixtures thereof, such as carboxylic acid monomers, sulfonic acid monomers, phosphorous-containing acid monomers, salts thereof, or mixtures thereof. Examples of suitable phosphorous-containing acid monomers and salts thereof include phosphoalkyl (meth)acrylates such as phosphoethyl (meth)acrylate, phosphopropyl (meth)acrylate, phosphobutyl (meth)acrylate, salts thereof, or mixtures thereof; CH₂═C(R₁)—C(O)—O—(R₂O)_{q}—P(O)(OH)₂, wherein R₁═H or CH₃, R₂=alkylene, such as an ethylene group, a propylene group, or a combination thereof; and q=1-20, such as SIPOMER PAM-100, SIPOMER PAM-200, SIPOMER PAM-300, SIPOMER PAM-600 and SIPOMER PAM-4000 all available from Solvay; phosphoalkoxy (meth)acrylates such as phospho ethylene glycol (meth)acrylate, phospho di-ethylene glycol (meth)acrylate, phospho tri-ethylene glycol (meth)acrylate, phospho propylene glycol (meth)acrylate, phospho di-propylene glycol (meth)acrylate, phospho tri-propylene glycol (meth)acrylate, salts thereof, or mixtures thereof. Preferred phosphorus-containing acid monomers and salts thereof are selected from the group consisting of phosphoethyl (meth)acrylate, phosphopropyl (meth)acrylate, phosphobutyl (meth)acrylate, allyl ether phosphate, salts thereof, or mixtures thereof; more preferably, phosphoethyl methacrylate (PEM). The carboxylic acid monomers can be α, β-ethylenically unsaturated carboxylic acids, monomers bearing an acid-forming group which yields or is subsequently convertible to, such an acid group (such as anhydride, (meth)acrylic anhydride, or maleic anhydride); or mixtures thereof. Specific examples of carboxylic acid monomers include acrylic acid, methacrylic acid, maleic acid, itaconic acid, crotonic acid, fumaric acid, 2-carboxyethyl acrylate, or mixtures thereof. The sulfonic acid monomers and salts thereof may include sodium vinyl sulfonate (SVS), sodium styrene sulfonate (SSS), acrylamido-methyl-propane sulfonate (AMPS) and salts thereof; or mixtures thereof. Preferred acid monomers are selected from acrylic acid, methacrylic acid, itaconic acid, or mixtures thereof. The hydroxyl-functional polymer may comprise structural units of the acid monomer and salt thereof in an amount of 0.1% or more, 0.3% or more, 0.5% or more, 0.8% or more, 1.0% or more, 1.3% or more, 1.5% or more, 1.7% or more, or even 2.0% or more, and at the same time, 10% or less, 8.0% or less, 7.0% or less, 6.0% or less, 5.0% or less, 4.5% or less, 4.0% or less, 3.5% or less, 3.0% or less, or even 2.5% or less, by weight based on the weight of the hydroxyl-functional polymer.

The hydroxyl-functional polymer useful in the present invention may comprise structural units of one or more ethylenically unsaturated functional monomer carrying at least one functional group selected from an amide, acetoacetate, carbonyl, ureido, silane, or amino group. Suitable ethylenically unsaturated functional monomers may include, for example, amino-functional monomers such as dimethylaminoethyl methacrylate, dimethylaminoethyl acrylate, dimethylaminopropyl methacrylate, dimethylaminopropyl acrylate; ureido-functional monomers such as hydroxyethyl ethylene urea methacrylate, hydroxyethyl ethylene urea acrylate, such as SIPOMER WAM II; monomers bearing acetoacetate-functional groups such as acetoacetoxyethyl methacrylate (AAEM), acetoacetoxyethyl acrylate, acetoacetoxypropyl methacrylate, acetoacetoxypropyl acrylate, allyl acetoacetate, acetoacetoxybutyl methacrylate, acetoacetoxybutyl methacrylate, acetoacetamidoethyl methacrylate, acetoacetamidoethyl acrylate; monomers bearing carbonyl-containing groups such as diacetone acrylamide (DAAM), diacetone methacrylamide; monomers bearing amide-functional groups such as acrylamide and methacrylamide; vinyltrialkoxysilanes such as vinyltrimethoxysilane, vinyltriethoxysilane, vinyltris(2-methoxyethoxy)silane, vinyldimethylethoxysilane, vinylmethyldiethoxysilane, or (meth)acryloxyalkyltrialkoxysilanes such as (meth)acryloxyethyltrimethoxysilane and (meth)acryloxypropyltrimethoxysilane; or mixtures thereof. The hydroxyl-functional polymer may comprise structural units of the ethylenically unsaturated functional monomer in an amount of zero or more, 0.1% or more, 0.5% or more, 1% or more, 1.5% or more, or even 2% or more, and at the same time is typically 10% or less, 8% or less, 6% or less, 5% or less, or even 3% or less, by weight based on the weight of the hydroxyl-functional polymer.

The hydroxyl-functional polymer useful in the present invention comprises structural units of one or more monoethylenically unsaturated nonionic monomer that is different from the monomers described above. “Nonionic monomer” herein refers to a monomer that does not bear an ionic charge between pH=1-14. Monoethylenically unsaturated nonionic monomers may include vinyl aromatic monomers, alkyl (meth)acrylates, acrylonitrile, or mixtures thereof. Suitable vinyl aromatic monomers may include, for example, styrene; substituted styrene such as methylstyrene, alpha-methylstyrene, trans-beta-methylstyrene, 2,4-dimethylstyrene, ethylstyrene, butylstryene, and p-methoxystyrene; o-, m-, and p-methoxystyrene; and p-trifluoromethylstyrene; or mixtures thereof. The alkyl (meth)acrylates can be C₁-C₂₀-alkyl, C₁-C₁₈-alkyl, C₁-C₁₂-alkyl, or C₁-C₄-alkyl (meth)acrylates. Specific examples of alkyl (meth)acrylates include methyl acrylate, methyl methacrylate, ethyl acrylate, ethyl methacrylate, butyl acrylate, butyl methacrylate, tert-butyl acrylate, tert-butyl methacrylate, iso-butyl acrylate, iso-butyl methacrylate, 2-ethylhexyl acrylate, nonyl acrylate, decyl acrylate, lauryl acrylate, cyclohexyl methacrylate, cyclohexyl acrylate, tert-butyl cyclohexyl methacrylate, trimethylcyclohexyl methacrylate, isobornyl methacrylate, isobornyl acrylate, tetrahydrofuran methacrylate, dicyclopentadienyl acrylate, dicyclopentadienyl methacrylate, and combinations thereof. The monoethylenically unsaturated nonionic monomers preferably include styrene in combination of one or more alkyl (meth)acrylate. Preferred monoethylenically unsaturated nonionic monomers are styrene, methyl methacrylate, cyclohexyl methacrylate, tert-butyl methacrylate, butyl acrylate, 2-ethylhexyl acrylate, or mixtures thereof. The hydroxyl-functional polymer may comprise structural units of the monoethylenically unsaturated nonionic monomer in an amount of 30% or more, 35% or more, 40% or more, 45% or more, 50% or more, 55% or more, or even 60% or more, and at the same time, 80% or less, 77% or less, 75% or less, 74% or less, or even 72% or less, by weight based on the weight of the hydroxyl-functional polymer.

The hydroxyl-functional polymer useful in the present invention may comprise structural units of one or more multiethylenically unsaturated monomer including di-, tri-, tetra-, or higher multifunctional ethylenically unsaturated monomers. Examples of suitable multiethylenically unsaturated monomers include butadiene, allyl (meth)acrylate, divinyl benzene, ethylene glycol dimethacrylate, butylene glycol dimethacrylate, or mixtures thereof. The hydroxyl-functional polymer may comprise structural units of the multiethylenically unsaturated monomer in an amount of zero to 5%, for example, 3% or less, 1% or less, 0.5% or less, or even zero, by weight based on the weight of the hydroxyl-functional polymer.

The hydroxyl-functional polymer useful in the present invention may have a weight average molecular weight of 50,000 g/mol or less, for example, 5,000 g/mol or more, 6,000 g/mol or more, 7,000 g/mol or more, 8,000 g/mol or more, 9,000 g/mol or more, 10,000 g/mol or more, 11,000 g/mol or more, 12,000 g/mol or more, 13,000 g/mol or more, 14,000 g/mol or more, 15,000 g/mol or more, 16,000 g/mol or more, 17,000 g/mol or more, 18,000 g/mol or more, or even 19,000 g/mol or more, and at the same time, 50,000 g/mol or less, 48,000 g/mol or less, 45,000 g/mol or less, 42,000 g/mol or less, 40,000 g/mol or less, 38,000 g/mol or less, 35,000 g/mol or less, 32,000 g/mol or less, 30,000 g/mol or less, 28,000 g/mol or less, 25,000 g/mol or less, 23,000 g/mol or less, or even 20,000 g/mol or less. Weight average molecular weight of the hydroxyl-functional polymer herein can be determined by Gel Permeation Chromatography (GPC) as described in the Examples section below.

The hydroxyl-functional polymer particles dispersed in the aqueous dispersion may have a particle size of from 30 to 500 nanometers (nm), for example, 50 nm or more, 60 nm or more, 70 nm or more, or even 80 nm or more, and at the same time, 300 nm or less, 200 nm or less, 150 nm or less, 120 nm or less, or even 100 nm or less. The particle size herein refers to Z-average size and may be measured by a Brookhaven BI-90 Plus Particle Size Analyzer.

The hydroxyl-functional polymer useful in the present invention may be present in an amount of from 20% to 70%, from 30% to 55%, from 35% to 50%, or from 40% to 45%, by weight based on the total weight of the aqueous dispersion (A).

The aqueous dispersion comprising the hydroxyl-functional polymer useful in the present invention may be prepared by free radical polymerization such as solution polymerization or emulsion polymerization of a monomer mixture comprising the hydroxy-functional alkyl (meth)acrylate, the acid monomer and/or salt thereof, the monoethylenically unsaturated nonionic monomer, and optionally, the ethylenically unsaturated functional monomer, in a liquid medium. The hydroxyl-functional polymer is preferably an emulsion polymer, i.e., prepared by emulsion polymerization.

The aqueous dispersion comprising the hydroxyl-functional polymer can be prepared by solution polymerization of the monomer mixture, and subsequently dispersing the resulting hydroxyl-functional polymer in water, before, during, or after the addition of a neutralizing agent. The solution polymerization is typically carried out at temperatures ranging from 40 to 200° C., from 60 to 180° C., or from 80 to 160° C. It is optional to employ organic solvents in minor amounts, for example, in an amount of from zero to 5% by weight of the finished dispersion of the hydroxyl-functional polymer. Suitable solvents may include, for example, alcohols, ethers, alcohols containing ether groups, esters, ketones, apolar hydrocarbons, or mixtures thereof. The solvents used can be partially removed by distillation. Preferred solution polymerization is a two-stage addition comprising a first step (I) for forming a first stage polymer and a subsequent step (II) for forming the second stage polymer in the presence of the reaction mixture obtained from step (I). The first stage polymer may comprise, by weight based on the weight of the first stage polymer, structural units of the hydroxy-functional monomer in an amount of from 2.8% to 70%, from 3.5% to 45%, or from 23% to 38%; and structural units of the acid monomer and salt thereof in an amount of from zero to 1.5%, from zero to 0.6%, and from zero to 0.45%. The second stage polymer may comprise, by weight based on the weight of the second stage polymer, structural units of the hydroxy-functional monomer in an amount of from 4.5% to 47%, from 4.5% to 44%, or from 11.5% to 38%; and structural units of the acid monomer and salt thereof in an amount of from 1.5% to 6%, from 2% to 5.5%, or from 2.1% to 4.5%. The monomer amounts of the two polymer preparations are chosen such that the weight ratio of the first stage polymer from step (I) to the second stage polymer from step (II) is in the range of from 10:1 to 1:2 or from 6:1 to 2:1.

The aqueous dispersion comprising the hydroxyl-functional polymer may be prepared by emulsion polymerization in an aqueous medium and, preferably in the presence of a surfactant. The surfactant may be added prior to or during the polymerization of the monomers, or combinations thereof. A portion of the surfactant can also be added after the polymerization. These surfactants can be anionic or nonionic, preferably, anionic surfactants such as sulphate surfactants, sulfonate surfactants, or mixtures thereof. These surfactants may be used in a combined amount of 0.1% or more, 0.3% or more, 0.5% or more, 0.7% or more, 0.9% or more, or even 1.2% or more, and at the same time, 5% or less, 4% or less, 3% or less, 2% or less, or even 1.5% or less, by weight based on the total weight of the monomer mixture for preparing the hydroxyl-functional polymer. The monomer mixture may be added neat or as an emulsion in water; or added in one or more addition or continuously, linearly or nonlinearly, over the reaction period of preparing the hydroxyl-functional polymer. Total concentration of the monomers in the monomer mixture for preparing the hydroxyl-functional polymer is equal to 100%. For each monomer, the weight concentration of a monomer in the monomer mixture (that is, based on the total weight of the monomer mixture) is the same as the weight concentration of structural units of such monomer in the hydroxyl-functional polymer (that is, based on the weight of the hydroxyl-functional polymer). Temperatures suitable for emulsion polymerization of the monomers may be lower than 100° C., in the range of from 10 to 95° C., or in the range of from 50 to 92° C. Multistage emulsion polymerization using the monomers described above can be used, which at least two stages are formed sequentially, and usually results in the formation of the multistage polymer comprising at least two polymer compositions.

Free radical initiators may be used in the polymerization process. The polymerization process may be thermally initiated or redox initiated emulsion polymerization. Examples of suitable free radical initiators for emulsion polymerization include hydrogen peroxide, t-butyl hydroperoxide, cumene hydroperoxide, ammonium and/or alkali metal persulfates, sodium perborate, perphosphoric acid and salts thereof, potassium permanganate, and ammonium or alkali metal salts of peroxydisulfuric acid, or mixture thereof. Examples of suitable initiators for solution polymerization include organic peroxides such as di-tert-butyl peroxide or tert-butyl peroxy-2-ethylhexanoate, azo compounds such as azodiisobutyronitrile (AIBN), or mixtures thereof. The free radical initiators may be used typically at a level of 0.01% to 3.0% by weight, based on the total weight of the monomers.

Redox systems comprising the above described initiators coupled with a suitable reductant may be used in the polymerization process, preferably emulsion polymerization. Examples of suitable reductants include sodium sulfoxylate formaldehyde, ascorbic acid, isoascorbic acid, alkali metal and ammonium salts of sulfur-containing acids, such as sodium sulfite, bisulfite, thiosulfate, hydrosulfite, sulfide, hydrosulfide or dithionite, formadinesulfinic acid, acetone bisulfite, glycolic acid, hydroxymethanesulfonic acid, glyoxylic acid hydrate, lactic acid, glyceric acid, malic acid, tartaric acid and salts of the preceding acids. Metal salts of iron, copper, manganese, silver, platinum, vanadium, nickel, chromium, palladium, or cobalt may be used to catalyze the redox reaction. Chelating agents for the metals may be used.

One or more chain transfer agent may be used in the polymerization process to control the molecular weight of the hydroxyl-functional polymer made by emulsion polymerization. Examples of suitable chain transfer agents include 3-mercaptopropionic acid, methyl 3-mercaptopropionate, butyl 3-mercaptopropionate, n-dodecyl mercaptan, n-hexadecanethiol, tert-dodecyl mercaptan, n-octadecanethiol, benzenethiol, azelaic alkyl mercaptan, hydroxy group containing mercaptans such as hydroxyethyl mercaptan, mercaptopropionic acid, or mixtures thereof. The chain transfer agent may be used in an effective amount to control the molecular weight of the hydroxyl-functional polymer, for example, greater than 0.3%, from 0.4% to 20%, from 0.5% to 15%, from 0.6% to 13%, from 0.8% to 10%, from 1% to 8%, from 1.3% to 6%, from 1.5% to 4%, from 1.5% to 3%, or from 2.0% to 2.5%, by weight based on the total weight of the monomer mixture.

After completing the polymerization process, the obtained hydroxyl-functional polymer dispersion may be neutralized by one or more base as a neutralizing agent to a pH value, for example, at least 5, from 5.5 to 10, from 6.0 to 9, from 6.2 to 8, from 6.4 to 7.5, or from 6.6 to 7.2. For the solution polymerization, before, during or after dispersing the hydroxy-functional polymer in water at least a portion of the acid groups present are converted into their salt form by adding suitable neutralizing agents. Examples of suitable bases include ammonia; alkali metal or alkaline earth metal compounds such as sodium hydroxide, potassium hydroxide, calcium hydroxide, zinc oxide, magnesium oxide, sodium carbonate, aluminum hydroxide; primary, secondary, and tertiary amines such as N-methyl morpholine, triethylamine, ethyl diisopropylamine, N,N-dimethylethanolamine, N,N-dimethylisopropanolamine, N-methyldiethanolamine, diethylethanolamine, butanolamine, 2-aminomethyl-2-methylpropanol, isophorone diamine, triethyl amine, ethylamine, propylamine, monoisopropylamine, monobutylamine, hexylamine, ethanolamine, diethyl amine, dimethyl amine, di-n-propylamine, tributylamine, triethanolamine, dimethoxyethylamine, 2-ethoxyethylamine, 3-ethoxypropylamine, dimethylethanolamine, diisopropanolamine, morpholine, ethylenediamine, 2-diethylaminoethylamine, 2,3-diaminopropane, 1,2-propylenediamine, neopentanediamine, dimethylaminopropylamine, hexamethylenediamine, 4,9-dioxadodecane-1,12-diamine, polyethyleneimine or polyvinylamine; or mixtures thereof.

Types and levels of the monomers described above may be chosen to provide the obtained hydroxyl-functional polymer with a glass transition temperature (Tg) in the range of from 10 to 80° C., from 15 to 75° C., from 20 to 70° C., from 25 to 65° C., from 30 to 60° C., from 35 to 55° C., or from 40 to 50° C. “Tg” as used herein may be determined by differential scanning calorimetry (DSC) according to the test method described in the Examples section below.

In addition to the hydroxyl-functional polymer, the aqueous dispersion (A) in polyurethane composition may further comprise one or more alcohol alkoxylate. Preferably, the aqueous dispersion comprises the emulsion polymer and one or more alcohol alkoxylate. The alcohol alkoxylate useful in the present invention may have formula (I),

R¹—O—(CHR³—CHR⁴—O)ₓ—(CH₂CH₂—O)_{y}—(CHR⁵—CHR⁶—O)_{z}—R² (I)

where R¹ is a C₆-C₁₈ branched aliphatic group; preferably, R¹ contains from 8 to 18 carbon atoms, from 8 to 16 carbon atoms, from 8 to 14 carbon atoms, from 10 to 14 carbon atoms, or from 12 to 14 carbon atoms; and more preferably, R¹ is 2-ethyl hexyl or

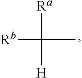

where R^{a} and R^{b} are each independently a C₁-C₁₇ aliphatic group, provided that R^{a} and R^{b} together contain from 7 to 17 carbon atoms, from 7 to 15 carbon atoms, from 7 to 13, or from 11 to 13 carbon atoms;

R² is hydrogen, a C₁-C₄ linear or branched aliphatic group, or benzyl; preferably, hydrogen;

R³ and R⁴ are each independently hydrogen or a C₁-C₆ aliphatic group, provided that R³ and R⁴ together contain from 1 to 6 carbon atoms; preferably, R³ and R⁴ are each independently hydrogen, methyl, or ethyl;

R⁵ and R⁶ are each independently hydrogen or a C₁-C₆ aliphatic group, provided that R⁵ and R⁶ together contain from 1 to 6 carbon atoms; preferably, R⁵ and R⁶ are each independently hydrogen, methyl, or ethyl;

x is an average value ranging from 0 to 10, from 0 to 8, from 2 to 7, or from 3 to 6;

y is an average value ranging from 5 to 15, from 5 to 14, from 6 to 13, or from 7 to 12;

z is an average value ranging from 0 to 5, from 0 to 4, from 0.5 to 3.5, or from 1 to 3;

provided that x+z>0.

“Aliphatic group” refers to a hydrocarbon chain (e.g. an alkyl group). The total value of x, y, and z in formula (I) can be a value sufficient to give the alcohol alkoxylate a desirable molecular weight, for example, from 5.5 to 20, from 7 to 17, from 8 to 16, or from 9 to 15.

The alcohol alkoxylate useful in the present invention may have a molecular weight in the range of 1,000 gram per mole (g/mol), for example, 400 g/mol or more, 420 g/mol or more, 440 g/mol or more, 450 g/mol or more, 460 g/mol or more, 480 g/mol or more, 500 g/mol or more, 520 g/mol or more, 550 g/mol or more, 560 g/mol or more, 580 g/mol or more, 600 g/mol or more, 620 g/mol or more, 650 g/mol or more, 660 g/mol or more, or even 680 g/mol or more, and at the same time, 980 g/mol or less, 960 g/mol or less, 950 g/mol or less, 940 g/mol or less, 920 g/mol or less, 910 g/mol or less, 900 g/mol or less, 880 g/mol or less, 860 g/mol or less, 850 g/mol or less, 840 g/mol or less, or even 820 g/mol or less. Molecular weight herein refers to number average molecular weight (Mn) and calculated by 56100 (mg/mol)/OHV (mgKOH/g), where OHV represents hydroxyl value of the alcohol alkoxylate as determined by ASTM D4274-2011.

The alcohol alkoxylate useful in the present invention may comprise ethylene oxide units (also as ethylene oxide chains, —(CH₂CH₂—O)—) in an amount of 25% or more, 26% or more, 27% or more, 28% or more, 29% or more, 30% or more, 32% or more, 35% or more, 38% or more, 40% or more, 42% or more, 45% or more, 48% or more, or even 50% or more, at the same time, 75% or less, 72% or less, 70% or less, 68% or less, 67% or less, 66% or less, 65% or less, or even 64% or less, by weight based on the weight of the alcohol alkoxylate.

The alcohol alkoxylate useful in the present invention may have the structure of formula (I), wherein R³ and R⁴ are different and each independently hydrogen or methyl, z is 0, and the total value of x and y is from 7 to 14. Preferably, R¹ is 2-ethyl hexyl. More preferably, the ethylene oxide units are present in an amount of 30% to 70% or from 35% to 60%, by weight based on the weight of the alcohol alkoxylate.

The alcohol alkoxylate useful in the present invention may have the structure of formula (I), wherein R⁵ and R⁶ are different and each independently hydrogen or ethyl, x is 0, y is from 7 to 14, and z is from 1 to 2. Preferably, R¹ is a

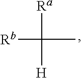

R^{a} and R^{b} are as defined above, for example, R^{a} and R^{b} together contain from 11 to 13 carbon atoms. More preferably, the ethylene oxide units are present in an amount of 40% to 70% or from 45% to 68%, by weight based on the weight of the alcohol alkoxylate.

The alcohol alkoxylate useful in the present invention may be present in the aqueous dispersion (A) in an amount of 2% or more, 2.1% or more, 2.2% or more, 2.3% or more, 2.4% or more, 2.5% or more, 3% or more, 3.5% or more, 4% or more, 4.5% or more, 5% or more, 5.5% or more, 6% or more, 6.5% or more, 7% or more, 7.5% or more, 8% or more, 8.5% or more, 9% or more, 9.5% or more, or even 10% or more, at the same time, 20% or less, 19% or less, 18% or less, 17% or less, 16% or less, 15% or less, 14.5% or less, 14% or less, 13.5% or less, 13% or less, 12.5% or less, 12% or less, 11.5% or less, 11% or less, or even 10.5% or less, by weight based on the weight of the hydroxyl-functional polymer. The hydroxyl-functional polymer is preferably the emulsion polymer (i.e., hydroxyl-functional emulsion polymer). Surprisingly, the combination of the hydroxyl-functional emulsion polymer with the alcohol alkoxylate of formula (I) can provide the packaging layer for the battery device with many advantages including improved electrical insulation and impact resistance properties than using the hydroxyl-functional polymer prepared by solution polymerization alone, or higher DOI than using the hydroxyl-functional emulsion polymer alone.

A portion of the alcohol alkoxylate can be added prior to or during the polymerization of the monomer mixture used for preparing the hydroxyl-functional polymer, or combinations thereof, and the rest of the alcohol alkoxylate is added after the polymerization. Preferably, all of the alcohol alkoxylate in the polyurethane composition is mixed with the hydroxyl-functional polymer after its polymerization.

The polyurethane composition useful in the present invention further comprises (B) one or more polyisocyanate useful as a crosslinker. “Polyisocyanate” refers to any isocyanate functional molecule having two or more isocyanate (NCO) groups. Polyisocyanates can be aliphatic, alicyclic, aromatic, or mixtures thereof. The polyisocyanates may have an average functionality of >2 or from 2.5 to 10. Examples of suitable polyisocyanates include aliphatic diisocyanates, as well as dimers and trimers thereof, such as, for example, C₂-C₈ alkylene diisocyanates, such as tetramethylene diisocyanate and hexamethylene diisocyanate (HDI), 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate; alicyclic diisocyanates, as well as dimers and trimers thereof, such as, for example, isophorone diisocyanate (IPDI) and dicyclohexyl methane diisocyanate (HMDI), 1,4-cyclohexane diisocyanate, and 1,3-bis-(isocyanatomethyl)cyclohexane; aromatic diisocyanates, as well as dimers and trimers thereof, such as, for example, toluene diisocyanate (TDI), and diphenyl methane diisocyanate (MDI). Preferably, the polyisocyanate comprises aliphatic polyisocyanates. More preferably, the polyisocyanates are hexamethylene diisocyanate homopolymers, hexamethylene diisocyanate adducts, isophorone diisocyanate homopolymers, isophorone diisocyanate adducts, or mixtures thereof. The trimers (or isocyanurates) in the polyisocyanate may be prepared by methods known in the art, for example, as disclosed in U.S. Patent Publication No. 2006/0155095A1, by trimerizing an alicyclic diisocyanate (e.g. isophorone diisocyanate) in the presence of one or more trimerization catalyst, such as, for example, a tertiary amine or phosphine or a heterogeneous catalyst, and, if desired, in the presence of solvents and/or assistants, such as co-catalysts, expediently at elevated temperature, until the desired NCO content has been reached, and then deactivating the catalyst using inorganic and organic acids, the corresponding acid-halides and alkylating agents and, preferably, heating. Isocyanurate compositions containing isocyanurates from aliphatic diisocyanates may be formed by cyclizing aliphatic diisocyanates in the presence of one or more trimerization catalyst and then deactivating the catalyst. Any of the isocyanurates can be further modified by conventional methods to contain urethane, urea, imino-s-triazine, uretonimine or carbodiimide moieties. Preferably, the polyisocyanate useful in the present invention is selected from the group consisting of an aliphatic diisocyanate, a dimer or trimer thereof, or mixtures thereof.

The polyisocyanate useful in the present invention may include one or more polyisocyanate prepolymer, which may be formed by reaction of bis(isocyanotomethyl)cyclohexane and/or another aliphatic diisocyanate with a monol, diol, diamine, or monoamine, which is then modified by the reaction of additional isocyanate to form allophanate or biuret modified prepolymers. Such prepolymers may further comprise a polyalkoxy or polyether chain. Alternatively, such prepolymers can then be mixed with a trimerization catalyst giving an allophanate or biuret modified polyisocyanate isocyanurate compositions. Preparation of such allophanate or biuret prepolymers, followed by trimerization, is known in the art, see for example, U.S. Pat. Nos. 5,663,272 and 6,028,158. Suitable polyisocyanates may be modified by an ionic compound such as aminosulfonic acid.

The polyisocyanate useful in the present invention can be used alone or diluted with one or more solvent (also as “diluting solvent”) to form a polyisocyanate solution, prior to mixing with the part A. Suitable solvents can reduce the viscosity of the polyisocyanate and have no reactivity with the polyisocyanate. The solvent may be used in an amount of from 5% to 150%, from 15% to 130%, from 20% to 120%, or from 30% to 100%, by weight based on the weight of the polyisocyanate. Suitable diluting solvents may include, for example, propylene glycol diacetate, propylene glycol methyl ether acetate, dipropylene glycol dimethyl ether, or mixtures thereof.

The polyurethane composition useful in the present invention may have equivalent ratios of the total number of isocyanate group equivalents in the polyisocyanates, which may contain several different polyisocyanates, to the total number of hydroxyl group equivalents in the aqueous dispersion comprising the hydroxyl-functional polymer, and optionally, the alcohol alkoxylate, in the range of, for example, from 0.7:1 to 4:1, from 0.8:1 to 3:1, from 0.9:1 to 2.5:1, or from 1:1 to 1.5:1.

The polyurethane composition useful in the present invention may comprise one or more catalyst to enhance curing. The catalyst can be any suitable catalyst for two-component polyurethane composition, including, for example, metal-based catalysts such as tin-, bismuth-, zinc-, aluminum-, zirconium-containing catalysts or tertiary amine catalysts including aliphatic and cyclo-aliphatic tertiary amine catalysts which are mono-, di- or tri-amines, or mixtures thereof. Examples of suitable metal-based catalysts include dibutyltin dilaurate, dibutyltin mercaptide, dibutyltin sulfide, dimethyltin mercaptide, dibutyltin mercaptoester, zirconium dionate, Al dionate, bismuth neodecanoate, and zinc amine compounds. Suitable tertiary amine catalysts may include, for example, triethylene diamine, triethylene amine, 1,4-diazabicyclo[2.2.2]octane, 6-(dibutylamino)-1,8-diazabicyclo[5.4.0]undec-7-ene, dimethyl cyclohexyl amine, or mixtures thereof. The catalyst may be present in an amount of from 0.01% to 2.5% or from 0.1% to 1.0%, by weight based on the total polyisocyanate and hydroxy group-containing component solids (e.g., the hydroxyl-functional polymer, and optionally, the alcohol alkoxylate).

The polyurethane composition useful in the present invention may comprise one or more pigment. The term “pigment” herein refers to a particulate inorganic or organic material which is capable of materially contributing to the opacity, the color, or hiding capability of a coating. Pigments may be present in the part A of the polyurethane composition. Inorganic pigments typically having a refractive index greater than 1.8 may include, for example, titanium dioxide (TiO₂), zinc oxide, zinc sulfide, iron oxide, barium sulfate, barium carbonate, or mixtures thereof. Examples of suitable organic pigments include phthalo blue, phthalo green, monoazo yellow, carbon black, or mixtures thereof. Preferred pigment used in the present invention is TiO₂. The polyurethane composition may comprise one or more extender. The term “extender” refers to a particulate material having a refractive index of less than or equal to 1.8 and greater than 1.3. Examples of suitable extenders include calcium carbonate, aluminum oxide (Al₂O₃), clay, calcium sulfate, aluminosilicate, silicate, zeolite, mica, diatomaceous earth, solid or hollow glass, ceramic bead, and opaque polymers such as ROPAQUE™ Ultra E available from The Dow Chemical Company (ROPAQUE is a trademark of The Dow Chemical Company), or mixtures thereof. The polyurethane composition may have a pigment volume concentration (PVC) of from zero to 75%, from 5% to 50%, or from 10% to 30%. PVC may be determined by the equation: PVC=[Volume (Pigment+Extender)/Volume (Pigment+Extender+Binder)]×100%.

The polyurethane composition useful in the present invention may further comprise one or more coalescent. The term “coalescent” herein refer to a solvent that fuses polymer particles into a continuous film under ambient condition. Examples of suitable coalescents include dipropylene glycol n-butyl ether, propylene glycol n-butyl ether, propylene glycol methyl ether, 2-n-butoxyethanol, dipropylene glycol methyl ether, propylene glycol n-propyl ether, diethylene glycol monobutyl ether, ethylene glycol monobutyl ether, ethylene glycol monohexyl ether, triethylene glycol monobutyl ether, dipropylene glycol n-propyl ether, n-butyl ether, aromatic hydrocarbons such as Solvesso series from ExxonMobil, 2,2,4-trimethyl-1,3-pentanediol monoisobutyrate such as Texanol ester alcohol from Eastman, or mixtures thereof. The coalescent may be present in an amount of from zero to 50%, from 5% to 40%, or from 10% to 25%, by weight based on the weight of the hydroxyl-functional polymer.

The polyurethane composition useful in the present invention may further comprise conventional additives such as, for example, light stabilizers, ultraviolet (UV) absorbing compounds, leveling agents, wetting agents, dispersants, neutralizers, defoamers, or rheology modifiers, or mixtures thereof. These additives may be present in the part A. The polyurethane composition may comprise these additives in an amount of from zero to 20%, from 1 to 10%, by weight based on the weight of the polyurethane composition.

The polyurethane composition useful in the present invention may be prepared admixing the aqueous dispersion comprising the hydroxyl-functional polymer, and optionally, the alcohol alkoxylate in the part A, with the polyisocyanate in the part B, and optional components such as pigments. The polyisocyanate in the part B is preferably diluted with the solvent. The part A and the part B are be mixed immediately before application to form the polyurethane composition. The polyurethane composition may comprise volatile organic compounds in an amount of 400 grams per liter (g/L) or less, 350 g/L or less, 330 g/L or less, 300 g/L or less, 280 g/L or less, 250 g/L or less, 210 g/L or less, 150 g/L or less, 100 g/L or less, or even 50 g/L or less, as measured according to GB30981-2020 (China National Standard for Limit of Harmful Substances of Industrial Protective Coating). Using the polyurethane composition enables the method of the present invention to be conducted by using existing manufacturing facilities for packaging battery devices having metal shells. The battery device, typically a battery cell, may comprise an electrode core, an electrolyte solution, and the metal shell with the electrode core and electrolyte solution being located in the chamber of the metal shell.

The method of packaging the battery device of the present invention comprises admixing (A) the aqueous dispersion comprising the hydroxyl-functional polymer with (B) the polyisocyanate to form the polyurethane composition, and applying the polyurethane composition to the metal shell of the battery device. The metal shell is generally a layer of metal foil, which can act as a hermetic barrier around the battery device. The metal can be aluminum or its alloys. The battery devices may include battery cells, preferably, lithium based cells. The battery cell is generally flat and rectangular in shape, such as a flat battery. The polyurethane composition can be applied to the metal surface by incumbent means including brushing, dipping, rolling and spraying, preferably, spraying. The standard spray techniques and equipment for spraying such as air-atomized spray, air spray, airless spray, high volume low pressure spray, and electrostatic spray such as electrostatic bell application, and either manual or automatic methods can be used. The method of the present invention can be conducted without the step of applying an adhesive material to the metal shell prior to the application of the polyurethane composition.

The method of packaging the battery device of the present invention further comprises drying the applied polyurethane composition to form a packaging layer. Drying the polyurethane composition can be conducted at a temperature of 100° C. or less, 90° C. or less, 80° C. or less, 78° C. or less, 75° C. or less, 72° C. or less, or even 70° C. or less, and at the same time, at room temperature (15-30° C.), or at temperatures of 50° C. or more, 52° C. or more, 55° C. or more, 58° C. or more, or even 60° C. or more. Drying time may be varied depending on the drying temperatures, for example, generally 30 minutes (min) or more, and at the same time, 3 hours or less, 2 hours or less, or even 1 hour or less. The polyurethane composition, upon drying or curing, forms a polyurethane packaging layer. The packaging layer formed may have a dry film thickness of 30 microns (μm) or more, 35 μm or more, or even 40 μm or more, and at the same time, 120 μm or less, 115 μm or less, 110 μm or less, 105 μm or less, or even 100 μm or less. The packaging layer is able to directly attach to the surface of the metal shell without a layer of an adhesive material residing therebetween. The packaging layer can provide a conformal coating housing of the battery device. The packaging layer provides sufficient flexibility to wrap the metal shell and has the electrical insulation and mechanical properties necessary to provide the toughness and hermeticity required of the package. The packaging layer can serve as an electrical insulation layer while providing balanced properties to meet the requirements of the battery industry. The packaging layer is characterized by a volume resistivity (VR) of 10¹² (“1E+12”) ohm·cm or higher, 10¹³ (“1E+13”) ohm·cm or higher, or even 10¹⁴ (“1E+14”) ohm·cm or higher; impact resistance of 10 cm (0.91 kg) or higher, 40 cm or higher, 55 cm or higher, or even 60 cm or higher; and chemical resistance of 100 times or more. The packing layer may also provide an adhesion rating of 5B and/or a hardness of F or harder or H or harder. Preferably, the packaging layer also has good appearance as indicated by a DOI of 74 or more, 75 or more, 76 or more, 80 or more, or even 85 or more. DOI measures the sharpness of a reflected image on a surface (e.g., the surface of the packaging layer) and is an indication of the perfection of a reflection, and lack of haze or “orange peel” in a surface. The present invention also relates to a method of insulating the battery device by applying the polyurethane composition and drying the applied polyurethane composition to form an electrical insulation layer with a VR of 1E+12 ohm·cm or higher, and optionally, one or more of the above properties including chemical resistance, impact resistance, hardness, and DOI. These properties can be measured according to the test methods described in the Examples section below.

The present invention also provides a battery package (also as “battery enclosure” or “battery case”) obtained from the method of the present invention. The battery package comprises the battery device with the metal shell, which is encapsulated by the packaging layer (or the electrical insulation layer). The battery package encloses or encases the battery device with the metal shell as an inner layer of the battery package and the packaging layer as an outer layer of the battery package. The battery package useful in the present invention can be used for a variety of applications such as portable electronics power tools, and power supplies for vehicle applications including hybrid electric vehicles, plug in hybrid electric vehicles, and fully electric vehicles. The battery package can also be used for packaging devices for storage of electric energy generated from wind, water, or sun.

### EXAMPLES

Some embodiments of the invention will now be described in the following Examples, wherein all parts and percentages are by weight unless otherwise specified.

Styrene (ST), 2-ethylhexyl acrylate (EHA), methacrylic acid (MAA), acrylic acid (AA), and methyl methacrylate (MMA) are all available from Langyuan Chemical Co., Ltd.

Hydroxyethyl methacrylate (HEMA), n-Dodecyl mercaptan (n-DDM), t-butyl hydroperoxide (t-BHP), ammonia persulfate (APS), isoascorbic acid (IAA), and ethylenediamine tetraacetic acid (EDTA) tetrasodium salt are all available from Sinopharm Chemical Reagent Co., Ltd.

Phosphoethyl methacrylate (PEM) and acetoacetoxy ethyl methacrylate (AAEM) are available from Solvay.

DISPONIL Fes 993 (Fes 993) non-reactive surfactant, available from BASF, is a branched alcohol ethoxylate sulphate, sodium salt, with 11 ethylene oxide (EO) units.

DISPERBYK-190 dispersant (BYK-90) is available from BYK.

Tego Twin 4100 wetting agent is available from Evonik Industries.

BYK-345 wetting agent is available from BYK.

Ti-Pure R-706 titanium dioxide (pigment) is available from The Chemours Company.

TEGO Airex 902 W (902W) and TEGO Foamex 1488 defoamers are both available from Evonik Industries.

Desmodur N3600 hexamethylene diisocyanate trimer is available from Covestro.

Aquolin 268 water dispersible hexamethylene diisocyanate trimer is available from Wanhua.

UV-414 UV curable paint (100%) is available from Fangzhou High-tech Co., Ltd.

The following materials including alcohol alkoxylates in the below table are all available from The Dow Chemical Company (OROTAN, DOWANOL, ACRYSOL, PROSPERSE, PRIMAL and MAINCOTE are all trademarks of The Dow Chemical Company):

OROTAN™ 681 dispersant is available from The Dow Chemical Company.

DOWANOL™ DPnB dipropylene glycol n-butyl ether and DOWANOL PM propylene glycol methyl ether are used as coalescents.

DOWANOL PGDA propylene glycol diacetate and DOWANOL PMA glycol ether acetate are used as diluting solvents for polyisocyanates.

ACRYSOL™ RM-8W, ACRYSOL RM-5000, and ACRYSOL RM-845 rheology modifiers are hydrophobically modified ethylene oxide urethanes (HEUR).

PROSPERSE™ 500 (P-500) secondary dispersion (solids: 47%) comprises a hydroxyl-functional acrylic copolymer having 30% structural units of hydroxyethyl methacrylate.

PROSPERSE 200 (P-200) emulsion (solids: 40%) comprises a hydroxyl-functional acrylic copolymer having 12% structural units of hydroxyethyl methacrylate.

MAINCOTE™ HG-54C emulsion (solids: 42%) comprises an acrylic copolymer containing no hydroxyl group.

PRIMAL™ BINDER U-91 (91UD) (solids: 42%) is an aqueous dispersion of an aliphatic polyurethane.

| Alcohol | | | |
|---|---|---|---|
| alkoxylate | Product description | EO % | Mn, g/mol |
| PAO1 | Ethoxylated and butoxylated | 55% | 710 |
| | C₁₂-C₁₄ secondary alcohol | | |
| PAO2 | Ethoxylated and butoxylated | 50% | 780 |
| | C₁₂-C₁₄ secondary alcohol | | |
| PAO3 | Ethoxylated and butoxylated | 62% | 840 |
| | C₁₂-C₁₄ secondary alcohol | | |
| PAO4 | Ethoxylated and propoxylated | 38% | 680 |
| | 2-ethyl hexanol | | |
| PAO5 | Ethoxylated and propoxylated | 48% | 820 |
| | 2-ethyl hexanol | | |
| PAO6 | Polyalkylene glycol | 75% | 980 |
| PAO7 | Butanol-initiated polyalkylene glycol | 50% | 750 |
| PAO8 | Polyalkylene glycol | 60% | 1900 |
| PAO9 | Polyethylene glycol | 100% | 600 |
| PAO10 | Dodecanol-initiated polyalkylene glycol | 0 | 950 |

The following standard analytical equipment and methods are used in the Examples and in determining the properties and characteristics stated herein:

### Particle Size Measurement

The particle size of polymer particles in an aqueous dispersion was measured by using Brookhaven BI-90 Plus Particle Size Analyzer, which employs the technique of photon correlation spectroscopy (light scatter of sample particles). This method involved diluting 2 drops of the aqueous dispersion to be tested in 20 mL of 0.01 M sodium chloride (NaCl) solution, and further diluting the resultant mixture in a sample cuvette to achieve a desired count rate (K) (e.g., K ranging from 250 to 500 counts/sec for diameter in the range of 10-300 nm). Then the particle size of the aqueous polymer dispersion was measured and reported as a Z-average diameter by intensity.

### Tg Measurement

A 5-10 milligram (mg) sample was analyzed in a sealed aluminum pan on a TA Instrument DSC Q2000 fitted with an auto-sampler under nitrogen atmosphere. Tg measurement by DSC was with three cycles including, from −40 to 180° C. at 10° C./min (1^{st} cycle, then hold for 5 min to erase thermal history of the sample), from 180 to −40° C. at 10° C./min (2^{nd} cycle), and from −40 to 180° C. at 10° C./min (3^{rd} cycle). Tg was obtained from the 3^{rd} cycle by taking the mid-point in the heat flow versus temperature transition as the Tg value.

### GPC Analysis

GPC analysis of polymers was performed generally by Agilent 1200. A sample was dissolved in tetrahydrofuran (THF)/formic acid (FA) (5%) with a concentration of 2 mg/mL and then filtered through 0.45 μm polytetrafluoroethylene (PTFE) filter prior to GPC analysis. The GPC analysis was conducted using the following conditions:

Column: One PLgel GUARD columns (10 μm, 50 millimeters (mm)×7.5 mm), Two Mixed B columns (7.8 mm×300 mm) in tandem; column temperature: 40° C.; mobile phase: THF/FA (5%); flow rate: 1.0 mL/min; Injection volume: 100 μL; detector: Agilent Refractive Index detector, 40° C.; and calibration curve: PL Polystyrene I Narrow standards with molecular weights ranging from 2329000 to 580 g/mol, using polynom 3 fitness.

### Hardness Test

Pencil hardness test was performed on coated steel panels (Q-panel R-46), according to ASTM D3363 (2011). The hardness of pencil lead was recorded when the pencil did not cut into or gouge the film. The hardness being F or harder is acceptable.

### Distinctness of Image (DOI) Test

DOI measurement was performed on coated aluminum panels (Q-panel A46), according to ASTM D5767-18 (Standard Test Methods for Instrumental Measurement of Distinctness-of-Image Gloss of Coating Surfaces), using a BYK Gardener micro-wave-scan meter (BYK-Gardner USA, Columbia, Md.). For each panel, an average of three separate readings was recorded for the DOI value. The higher DOI, the better. If the DOI of a coating is too low to be measured, the BYK Gardener micro-wave-scan meter reading will be shown as “not measurable, dullness>55” and recorded as “not measurable” in Table 3 below (when a reflected object is viewed in such a coating, its image becomes fuzzy and distorted).

### Solids Content

Solids content was measured by weighing 0.7±0.1 g of a sample (wet weight of the sample is denoted as “W1”), putting into an aluminum pan (weight of aluminum pan is denoted as “W2”) in an oven at 150° C. for 25 min, and then cooling the aluminum pan with the dried sample and weighing a total weight denoted as “W3”. Solids content of the sample is calculated by (W3-W2)/W1*100%.

### Dry Film Thickness Test

The dry film thickness (DFT) of coated aluminum panels (Q-panel A-46) was measured using BYKO-test 8500. An average of three separate readings was recorded.

### Volume Resistivity (VR) Test

The VR test was conducted on coated aluminum panels (Q-panel A46), according to ASTM D257-18. A Keithley 6517 B electrometer was used in combination with a Keithley 8009 test fixture. The Keithley model 8009 test chamber was placed inside a forced air oven, which is capable of operating at elevated temperatures (maximum 80° C.). The VR was calculated by the following equation:

$$ρ = \frac{V \times A}{I \times t}$$

where ρ is VR (ohm·cm), V is applied voltage (volt), A is electrode contact area (cm²), t is film thickness (cm), and I is leakage current (Ampere). The VR test was conducted at 1,000 volts at room temperature. The thickness of dry coating films on the coated panel was measured before the test. The leakage current was directly read from the instrument. For each panel, five points on the panel were measured and the averaged value was used in the equation above for VR calculation. For each sample, the VR test was repeated twice on two coated panels and two data points of VR values were averaged.

### Impact Resistance Test

Impact resistance was evaluated on coated aluminum panels (Q-panel A46) using a BYK GARDNER Impact Tester, according to ASTM D5420-10. The results are reported in cm (0.91 kg).

### Chemical Resistance Test

Methyl ethyl ketone (MEK) double rub resistance was used to evaluate the chemical resistance properties of coating films. MEK double rub resistance testing was performed on coated aluminum panels (Q-panel A46), according to ASTM D5402 (1999). An Atlas crockmeter was used to perform the double rubs and cheesecloth was used to hold enough MEK solution. The number of double rubs it took for the first breakthrough of the coating film to occur was recorded. Two measurements were performed on each coating film.

### Synthesis of Polymer Dispersion 1 (PD1)

A monomer emulsion was prepared by mixing 318 grams (g) of deionized (DI) water, Fes 993 surfactant (23 g, 30%), MMA (149 g), ST (306 g), EHA (176 g), HEMA (304 g), AAEM (51 g), MAA (16 g), PEM (16 g), and n-DDM (21 g). DI water (600 g) and Fes 993 surfactant (43 g, 30%) were charged to a five-liter multi-neck flask fitted with mechanical stirring. The contents of the flask were heated to 90° C. under nitrogen atmosphere. Then ammonia (2.5 g, 25%) in DI water (16.9 g), the monomer emulsion (29 g), and ammonium persulfate (APS) (2.0 g) in DI water (16.9 g) were added to the stirred flask, followed by a rinse of DI water (3.75 g). The remaining monomer emulsion was further added at 86° C. over 160 min, followed by a rinse of DI water (30 g). At the end of polymerization, FeSO₄·7H₂O (0.005 g) in DI water (15.75 g) mixed with EDTA tetrasodium salt (0.005 g) in DI water (15.75 g), a solution of t-BHP (1.6 g, 70%) in DI water (32.8 g) and a solution of IAA (0.8 g) in DI water (34.3 g), a solution of t-BHP (0.8 g) in DI water (16.4 g), and a solution of IAA (0.4 g) in DI water (17.2 g) were all added to the flask at 60° C., then ammonia (7.0 g, 25%) in DI water (16.65 g) was added at 50° C. to obtain an aqueous dispersion.

### Synthesis of Polymer Dispersion 2 (PD2)

A monomer emulsion was prepared by mixing DI water (271 g), Fes 993 surfactant (40.4 g, 30%), MMA (144 g), ST (281 g), EHA (161 g), HEMA (278 g), AAEM (46 g), AA (12 g), PEM (7 g), and n-DDM (37 g). DI water (568 g) and Fes 993 surfactant (20 g, 30%) were charged to a five-liter multi-neck flask fitted with mechanical stirring. The contents of the flask were heated to 90° C. under nitrogen atmosphere. Then, aqueous ammonia (2.3 g, 25%) in DI water (18 g), the monomer emulsion (76 g), and APS (1.9 g) in DI water (22 g) were added to the stirred flask, followed by a rinse of DI water (4 g). The remaining monomer emulsion was further added at 86° C. over 160 min, followed by a rinse of DI water (30 g). At the end of polymerization, FeSO₄·7H₂O (0.005 g) in DI water (15.75 g) mixed with EDTA tetrasodium salt (0.005 g) in DI water (15.75 g), a solution of t-BHP (1.4 g, 70% aqueous solution) in DI water (26 g), a solution of IAA (0.7 g) in DI water (26 g), a solution of t-BHP (0.4 g) in DI water (8 g), and a solution of IAA (0.2 g) in DI water (8 g) were all added to the flask at 60° C., then ammonia (7.0 g, 25%) in DI water (16.65 g) was added at 50° C. to obtain an aqueous dispersion.

### Synthesis of Polymer Dispersion 3 (PD3)

PD3 was prepared as in synthesis of PD2 except the monomer emulsion was prepared by mixing DI water (271 g), Fes 993 surfactant (30%) (40.4 g), MMA (144 g), ST (281 g), EHA (161 g), HEMA (278 g), AAEM (46 g), AA (12 g), PEM (7 g), and n-DDM (9 g).

### Synthesis of Polymer Dispersion 4 (PD4)

PD4 was prepared as in synthesis of PD2 except the monomer emulsion was prepared by mixing DI water (271 g), Fes 993 surfactant (40.4 g, 30%), MMA (146 g), ST (363 g), EHA (78 g), HEMA (278 g), AAEM (46 g), AA (12 g), PEM (7 g), and n-DDM (19 g).

### Synthesis of Polymer Dispersion 5 (PD5)

PD5 was prepared as in synthesis of PD2 except the monomer emulsion was prepared by mixing DI water (271 g), Fes 993 surfactant (30%) (40.4 g), MMA (31 g), ST (282 g), EHA (275 g), HEMA (278 g), AAEM (46 g), AA (12 g), PEM (7 g), and n-DDM (19 g).

Properties of the obtained emulsion polymer dispersions are given in Table 1.

TABLE 1
Properties of Dispersions of Emulsion Polymers

| Polymer | Particle | | Solids | Viscosity¹ | Measured | | |
|---|---|---|---|---|---|---|---|
| Dispersion | size (nm) | pH | (%) | (centipoise) | Tg² (° C.) | Mn³ | Mw³ |
| PD1 | 87 | 6.90 | 40.00 | 2001 | 38 | 7412 | 16860 |
| PD2 | 99 | 6.51 | 41.56 | 246 | 30 | 5286 | 15513 |
| PD3 | 96 | 6.87 | 40.74 | 317 | 47 | 6786 | 24861 |
| PD4 | 99 | 7.21 | 41.00 | 396 | 63 | 3368 | 16671 |
| PD5 | 102 | 6.60 | 40.80 | 759 | 15 | 3013 | 14564 |

¹Viscosity measured by Brookfield viscometer DV-I Primer (60 rpm, spindle #2);
²Tg measured by DSC;
³Mₙ and Mw obtained by the GPC analysis described above.

### Examples (Exs) 1-10, 15-18 and 20-24 and Comparative (Comp) Exs C, D and E Packaging Material Compositions

Exs 1-10, 15-18 and 20-24 and Comp Ex E were prepared based on formulations given in Table 2-1. Comp Exs C and D were prepared based on formulations given in Table 2-2. Types of alcohol alkoxylates (AOs) used for preparing packaging material compositions are listed in Table 3. For preparing two-component compositions, ingredients for preparing grinds were mixed using a high speed Cowles disperser at 1,500 revolutions per minute (rpm) for 30 min to form the grinds. Then ingredients in the letdown were added to the grinds using a conventional lab mixer to obtain the part A. The part A was left overnight, and then part B was added into the part A using a high speed disperser at 600 rpm for 10 min to form each packaging material composition. For preparing one-component packaging material compositions of Comp Exs C and E, ingredients were mixed using a high speed Cowles disperser at 1,500 rpm for 30 min to obtain the compositions.

Immediately after mixing all ingredients therein, the resultant packaging material compositions were applied onto the surface of a metal substrate (aluminum or steel panels) by spraying. After the wet paint film applied on the substrate, the obtained panels were dried under the following conditions: drying at room temperature for 20 min, and then drying at 60° C. for 40 min, and finally drying at room temperature for 7 days. The obtained coated panels with a coating film (i.e., packaging layer) thickness ranging from 30 μm to 200 μm were evaluated according to the test methods described above.

### Comp Exs A and B

UV-414 UV curable formulations were applied onto the surface of a metal substrate (aluminum or steel panels) by spraying at different film thickness. Immediately after spraying, the obtained panels were put into a UV curing machine (Heraeus F300S, xenon lamp), and irradiated for 10 seconds. The obtained coated panels with a dry film thickness of 60 μm and 100 μm, respectively, for Comp Exs A and B were evaluated according to the test methods described in the Examples section above.

TABLE 2-1
Packaging material compositions

| | | Exs 6-10 and | | | | | Comp |
|---|---|---|---|---|---|---|---|
| Formulation | Exs 1-5 | Exs 20-24 | Ex 15 | Ex 16 | Ex 17 | Ex 18 | Ex E |
| Part A, gram | 28.4 | 28.4 | 28.4 | 28.4 | 28.4 | 28.4 | |
| Grind | | | | | | | |
| Water | 4 | 4 | 4 | 4 | 4 | 4 | 4 |
| OROTAN 681 | 0.49 | 0.49 | 0.49 | 0.49 | 0.49 | 0.49 | 0.49 |
| Tego Twin 4100 | 0.15 | 0.15 | 0.15 | 0.15 | 0.15 | 0.15 | 0.15 |
| Ammonia (28%) | 0.2 | 0.2 | 0.2 | 0.2 | 0.2 | 0.2 | 0.2 |
| Ti-Pure R-706 | 17.05 | 17.05 | 17.05 | 17.05 | 17.05 | 17.05 | 17.05 |
| ACRYSOL RM-8W | 0.46 | 0.46 | 0.46 | 0.46 | 0.46 | 0.46 | 0.46 |
| Tego 902W | 0.05 | 0.05 | 0.05 | 0.05 | 0.05 | 0.05 | 0.05 |
| DI water | 6 | 6 | 6 | 6 | 6 | 6 | 6 |
| Letdown | | | | | | | |
| PROSPERSE P-500 | 41.4 | | | | | | |
| PD1 | | 42.67 | | | | | |
| PD2 | | | 41.07 | | | | |
| PD3 | | | | 41.89 | | | |
| PD4 | | | | | 41.63 | | |
| PD5 | | | | | | 41.83 | |
| 91UD | | | | | | | 70.7 |
| DI water | 8.91 | 3.41 | 5.01 | 4.19 | 4.45 | 4.25 | |
| Alcohol alkoxylate | | 2 | 2 | 2 | 2 | 2 | |
| DOWANOL DPnB | 0.58 | 2.08 | 2.08 | 2.08 | 2.08 | 2.08 | |
| DOWANOL PM | 0.38 | 1.39 | 1.39 | 1.39 | 1.39 | 1.39 | |
| ACRYSOL RM-8W | 0.2 | 0.2 | 0.2 | 0.2 | 0.2 | 0.2 | |
| NaNO₂ (15%) | 0.9 | 0.9 | 0.9 | 0.9 | 0.9 | 0.9 | 0.9 |
| Part B, gram | | | | | | | |
| Desmodur N3600 | 9.82 | 9.48 | 9.48 | 9.48 | 9.48 | 9.48 | |
| DOWANOL PGDA | 9.82 | 9.48 | 9.48 | 9.48 | 9.48 | 9.48 | |
| Total | 100 | 100 | 100 | 100 | 100 | 100 | 100 |
| Solids content | 46.12% | 46.12% | 46.12% | 46.12% | 46.12% | 46.12% | 46.12% |

TABLE 2-2
Packaging material compositions

| Formulation | Comp Ex C | Comp Ex D |
|---|---|---|
| Part A, gram | | |
| Grind | | |
| water | 5 | 5 |
| BYK-190 | 0.25 | 0.25 |
| Ti-Pure R-706 | 10 | 10 |
| Tego 902 W | 0.2 | 0.2 |
| Total | 15.45 | 15.45 |
| Letdown | | |
| MAINCOTE HG-54C | 65 | |
| PROSPERSE P-200 | | 50 |
| H₂O | 12.75 | 20.2 |
| DOWANOL DPnB | 6 | 6 |
| BYK-345 | 0.3 | 0.3 |
| Tego 902 W | 0.1 | 0.1 |
| Tego 1488 | 0.1 | 0.1 |
| ACRYSOL RM-5000 | 0.1 | 0.1 |
| ACRYSOL RM-845 | 0.2 | 0.2 |
| Part B, gram | | |
| PMA | | 1.51 |
| Aquolin 268 | | 6.04 |
| Total | 100 | 100 |
| Solids content | 37.3% | 37.2% |

### Ex 11 Packaging Material Composition

Ex 11 was prepared as in Ex 6 except the amounts of the alcohol alkoxylate and DI water used in the letdown stage were 1.6 g and 3.81 g, respectively.

### Ex 12 Packaging Material Composition

Ex 12 was prepared as in Ex 6 except the amounts of the alcohol alkoxylate and DI water used in the letdown stage were 1.2 g and 4.21 g, respectively.

### Ex 13 Packaging Material Composition

Ex 13 was prepared as in Ex 6 except the amounts of the alcohol alkoxylate and DI water used in the letdown stage were 1 g and 4.41 g, respectively.

### Ex 14 Packaging Material Composition

Ex 14 was prepared as in Ex 6 except the amounts of the alcohol alkoxylate and DI water used in the letdown stage were 0.5 g and 4.91 g, respectively.

### Ex 19 Packaging Material Composition

Ex 19 was prepared as in Ex 6 except the amount of DI water used in the letdown stage was 5.41 g and no alcohol alkoxylate was used.

The above obtained packaging material compositions were evaluated according to the test methods described above and results are given in Table 3. As shown in Table 3, Exs 1-24 all provided packaging layers with good electrical insulation as indicated by a volume resistance of 1E+12 ohm·cm or higher, good impact resistance (10 cm or more at 0.91 kg), sufficient chemical resistance (100 times or more), an adhesion rating of 5B, and a pencil hardness of F or harder. Particularly, Exs 6-18 comprising the hydroxyl-functional emulsion polymer and specific alcohol alkoxylates provided even better electrical insultation as indicated by a volume resistance of 1E+13 ohm·cm or higher, or even 1E+14 ohm·cm or higher, and better impact resistance. Moreover, Exs 1-18 also provided packaging layers with higher DOI (>74). In contrast, Comp Ex A packaging layer with a DFT of 60 μm formed from the UV curing paint provided undesirably low VR and poor impact resistance. Comp Ex B packaging layer with a DFT of 100 μm formed by the UV curing paint showed poor impact resistance. Packaging layers made from the one-component acrylic system HG-54C (Comp Ex C), the two-component PU system P-200 comprising 12% of structural units of HEMA (Comp Ex D), or the one-component PU dispersion 91UD (Comp Ex E) all showed poor chemical resistance and insufficient hardness.

TABLE 3
Formulations and properties of packaging materials

| | | | | | | | Impact | | | |
|---|---|---|---|---|---|---|---|---|---|---|
| | Resin | AO | AO | | DFT | VR | resistance | Chemical | | |
| | type | type | amount¹ | DOI ² | (μm) | (ohm · cm) | (cm) | resistance | Adhesion | Hardness |
| Ex 1 | P-500 | no | no | 81.9 | 40 | 2.65E+12 | 40 | 150 | 5B | F |
| Ex 2 | P-500 | no | no | 83.9 | 60 | 1.96E+12 | 40 | 210 | 5B | F |
| Ex 3 | P-500 | no | no | 84.2 | 80 | 1.59E+12 | 45 | 230 | 5B | F |
| Ex 4 | P-500 | no | no | 85.1 | 100 | 1.06E+12 | 40 | 236 | 5B | F |
| Ex 5 | P-500 | no | no | 83.6 | 120 | 1.27E+12 | 50 | 230 | 5B | F |
| Ex 6 | PD1 | PAO1 | 10% | 88.8 | 40 | 5.52E+13 | 75 | 203 | 5B | H |
| Ex 7 | PD1 | PAO2 | 10% | 78 | 35 | 9.71E+13 | 75 | 258 | 5B | H |
| Ex 8 | PD1 | PAO3 | 10% | 88.1 | 26 | 1.88E+14 | 75 | 327 | 5B | H |
| Ex 9 | PD1 | PAO4 | 10% | 88.5 | 35 | 1.27E+14 | 75 | 244 | 5B | H |
| Ex 10 | PD1 | PAO5 | 10% | 81.3 | 35 | 8.86E+13 | 75 | 261 | 5B | H |
| Ex 11 | PD1 | PAO1 | 8 | 83.5 | 39 | 9.80E+13 | 75 | 255 | 5B | H |
| Ex 12 | PD1 | PAO1 | 6 | 77.1 | 35 | 7.52E+13 | 75 | 368 | 5B | H |
| Ex 13 | PD1 | PAO1 | 5 | 76.1 | 39 | 1.03E+14 | 75 | 415 | 5B | H |
| Ex 14 | PD1 | PAO1 | 2.5% | 74.7 | 42 | 7.08E+13 | 75 | 605 | 5B | H |
| Ex 15 | PD2 | PAO1 | 10 | 81.1 | 38 | 7.27E+13 | 85 | 142 | 5B | H |
| Ex 16 | PD3 | PAO1 | 10% | 80.8 | 41 | 1.86E+14 | 65 | 406 | 5B | H |
| Ex 17 | PD4 | PAO1 | 10 | 87 | 38 | 1.34E+14 | 60 | 805 | 5B | H |
| Ex 18 | PD5 | PAO1 | 10% | 77.3 | 43 | 7.90E+13 | 85 | 120 | 5B | H |
| Ex 19 | PD1 | no | 0 | n.m. | 39 | 1.47E+14 | 81 | 718 | 5B | H |
| Ex 20 | PD1 | PAO6 | 10% | n.m. | 39 | 3.81E+13 | 94 | 460 | 5B | H |
| Ex 21 | PD1 | PAO7 | 10% | n.m. | 38 | 1.01E+14 | 97 | 304 | 5B | H |
| Ex 22 | PD1 | PAO8 | 10% | n.m. | 42 | 6.57E+13 | 97 | 371 | 5B | H |
| Ex 23 | PD1 | PAO9 | 10% | n.m. | 42 | 2.78E+13 | 97 | 435 | 5B | H |
| Ex 24 | PD1 | PAO10 | 10% | n.m. | 41 | 1.19E+14 | 97 | 170 | 5B | H |
| Comp | UV-414 | no | no | n.m. | 60 | 8.49E+11 | 5 | >1500 | 5B | F |
| Ex A | | | | | | | | | | |
| Comp | UV-414 | no | no | n.m. | 100 | 1.59E+12 | <5 | >1500 | 5B | H |
| Ex B | | | | | | | | | | |
| Comp | HG-54C | no | no | n.m. | 60 | 1.86E+13 | 30 | 4 | 5B | 3B |
| Ex C | | | | | | | | | | |
| Comp | P-200 | no | no | n.m. | 60 | 2.39E+12 | 20 | 50 | 5B | H |
| Ex D | | | | | | | | | | |
| Comp | 91-UD | no | no | n.m. | 45 | 1.34E+12 | 97 | 68 | 5B | HB |
| Ex E | | | | | | | | | | |

¹PAO dosage: by weight based on the dry weight of the emulsion polymer;
² n.m.—not measurable.

What is claimed is:

1. A method of packaging a battery device with a metal shell, comprising:
applying a waterborne two-component polyurethane composition to the metal shell of the battery device, and
drying the applied polyurethane composition to form a packaging layer;
wherein the polyurethane composition comprises,
(A) an aqueous dispersion comprising a hydroxyl-functional polymer, wherein the hydroxyl-functional polymer comprises, by weight based on the weight of the hydroxyl-functional polymer, from 20% to 50% of structural units of a hydroxy-functional alkyl (meth)acrylate, from 0.1% to 10% of structural units of an acid monomer, a salt thereof, or mixtures thereof, and structural units of a monoethylenically unsaturated nonionic monomer, and
(B) a polyisocyanate,
wherein the packaging layer has a thickness of from 30 μm to 120 μm, and wherein the packaging layer is directly attached to the surface of the metal shell without a layer of an adhesive material residing therebetween.

2. The method of claim 1, wherein drying polyurethane composition is conducted at a temperature of from 50 to 80° C.

3. The method of claim 1 wherein the hydroxyl-functional polymer is an emulsion polymer.

4. The method of claim 3, wherein the aqueous dispersion (A) further comprises from 2% to 20% of an alcohol alkoxylate, by weight based on the weight of the emulsion polymer.

5. The method of claim 4, wherein the
alcohol alkoxylate having a molecular weight of 1.000 g/mol or less has formula (I),
R¹—O—(CHR³—CHR⁴—O)ₓ—(CH₂CH₂—O)_{y}—(CHR⁵—CHR⁶—O)_{z}—R²
where R¹ is a C₆-C₁₈ branched aliphatic group; R² hydrogen, a C₁-C₄ linear or branched aliphatic group, or benzyl; R³ and R⁴ are each independently hydrogen or a C₁-C₆ aliphatic group, provided that R³ and R⁴ together contain from 1 to 6 carbon atoms; R⁵ and R⁶ are each independently hydrogen or a C₁-C₆ aliphatic group, provided that R⁵ and R⁶ together contain from 1 to 6 carbon atoms; x is an average value ranging from 0 to 10; y is an average value ranging from 5 to 15; and z is an average value ranging from 0 to 5; provided that x+z>0; wherein the alcohol alkoxylate comprises from 25% to 15% of ethylene oxide units, by weight based on the weight of the alcohol alkoxylate.

6. The method of claim 5, wherein
in formula (I), R¹ is 2-ethyl hexyl or 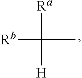
where R^{a} and R^{b} are each independently a C₁-C₁₇ aliphatic group, and R^{a} and R^{b} together contain from 7 to 17 carbon atoms.

7. The method of claim 1 wherein,
the hydroxyl-functional polymer has a weight average molecular weight of 50, 000 ft/mol or less.

8. The method of claim 1, wherein the hydroxyl-functional alkyl (meth)acrylate in selected from the group consisting of 2-hydroxyethyl acrylate, 2-hydroxyethyl methacrylate, 2-hydroxypropylacrylate, 2-hydroxypropyl methacrylate, or mixtures thereof.

9. The method of claim 1, wherein the hydroxy-functional
polymer has a glass transition temperature of from 10 to 80° C.

10. The method of claim 1, wherein the
polyisocyanate is selected from the group consisting of an aliphatic diisocyanate, dimers and trimers thereof, or mixtures thereof.

11. The method of claim 1, wherein the
equivalent ratio of the total number of isocyanate group equivalents in the polyisocyanate, to the total number of hydroxyl group equivalents in the aqueous dispersion is in the range of from 3:1 to 0.8:1.

12. The method of claim 1, wherein the
packaging layer is an electrical insulation layer with a volume resistance of 10¹² ohm·cm or higher at a film thickness of from 30 μm to 120 μm.

13. The method of claim 1, wherein the packaging layer
has a distinctness of image of 74 or higher.

14. The method of claim 1, wherein the metal shell is a layer of metal foil.

15. A battery package obtained from the method of claim 1.
